(19) United States
(12) Patent Application Publication
(10) Pub. No.: US 2026/0288048 A1
(43) Pub. Date: Sep. 24, 2026

(54) MEDIUM TRANSPORT DEVICE AND IMAGE FORMING APPARATUS

(71) Applicant: FUJIFILM Business Innovation Corp., Tokyo (JP)

(72) Inventors: Hiroyuki MOMIYAMA, Kanagawa (JP); Ryuga OISHI, Kanagawa (JP); Toshitaka TANAKA, Kanagawa (JP); Toshio KONDO, Kanagawa (JP)

(73) Assignee: FUJIFILM Business Innovation Corp., Tokyo (JP)

(21) Appl. No.: 19/298,161

(22) Filed: Aug. 12, 2025

(30) Foreign Application Priority Data
Mar. 24, 2025 (JP) 2025-049111

(51) Int. Cl. G03G 15/00

(52) U.S. Cl. CPC G03G 15/6567

(57) ABSTRACT

A medium transport device includes an abutting portion on which a leading edge of a transported recording medium abuts, a moving portion to which the abutting portion is attached, that is movable along a transport direction of the recording medium, and that moves to a downstream side in the transport direction at a speed slower than a transport speed of the recording medium in a state where the leading edge of the transported recording medium is abutting on the abutting portion, a retracting portion that retracts the abutting portion on which the leading edge of the recording medium is abutting, from a transport path of the recording medium, a rack gear provided in the moving portion, a pinion gear that meshes with the rack gear, that receives a rotational force transmitted from a motor, and that moves the moving portion provided with the rack gear by rotating, and a biasing portion that biases the moving portion to one side in a moving direction of the moving portion and that maintains a biasing force to be the same regardless of a moving position of the moving portion.

### CROSS-REFERENCE TO RELATED APPLICATIONS

This application is based on and claims priority under 35 USC 119 from Japanese Patent Application No. 2025-049111 filed Mar. 24, 2025.

### BACKGROUND

### (i) Technical Field

The present invention relates to a medium transport device and an image forming apparatus.

### (ii) Related Art

The paper sheet transport device according to JP2012-254847A includes an abutting portion that is provided to be capable of reciprocating along a transport direction of a paper sheet and that corrects oblique movement of the paper sheet by abutting on a leading edge of the paper sheet transported from an upstream side in the transport direction of the paper sheet. The paper sheet transport device includes a transport portion that transports the paper sheet transported in a state where the leading edge abuts on the abutting portion to a further downstream side, and an elastic deformation portion that elastically deforms as the abutting portion moves to the downstream side in the transport direction of the paper sheet and, in a case where the transport portion starts transporting the paper sheet, applies a force to the abutting portion to the upstream side in the transport direction of the paper sheet. The paper transport device includes a gear that is driven to rotate by a driving source, and a moving portion that is driven via the gear to cause the abutting portion to which the force is applied by the elastic deformation portion to reciprocate along the transport direction of the paper sheet and that causes the leading edge of the paper sheet to abut on the abutting portion moving to the downstream side in the transport direction of the paper sheet. The paper sheet transport device includes a separation portion that separates the abutting portion from the leading edge of the paper sheet after the transport portion starts transporting the paper sheet.

### SUMMARY

There is a medium transport device that forms a loop in a leading edge part of a transported recording medium to be transported by causing the leading edge of the transported recording medium to abut on an abutting member and moving the abutting member at a speed slower than a transport speed of the recording medium. In this medium transport device, oblique movement (skew) of the recording medium is eliminated by forming the loop in the leading edge part of the recording medium, and the recording medium is transported by retracting the abutting member.

In the related art, a rack-and-pinion driving mechanism is used for moving the abutting member. In such a configuration, the abutting member is attached to the moving portion provided with a rack gear. The abutting member attached to the moving portion is moved by transmitting a rotational force from a motor to a pinion gear meshing with the rack gear. Here, the moving portion may be biased to one side in a moving direction of the moving portion to reduce occurrence of a backlash in meshing between the rack gear and the pinion gear.

However, depending on a moving position of the moving portion, a biasing force provided to the moving portion by a spring changes, and movement of the moving portion is not stable. Accordingly, a position of the moving portion in passing the recording medium to a subsequent step varies between recording media.

Aspects of non-limiting embodiments of the present disclosure relate to a medium transport device and an image forming apparatus that reduce variation in a position of a moving portion between recording media in passing a recording medium to a subsequent step after reducing occurrence of a backlash in meshing between a rack gear and a pinion gear, compared to a case where the moving portion is biased to one side in a moving direction using a spring.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a medium transport device including an abutting portion on which a leading edge of a transported recording medium abuts, a moving portion to which the abutting portion is attached, that is movable along a transport direction of the recording medium, and that moves to a downstream side in the transport direction at a speed slower than a transport speed of the recording medium in a state where the leading edge of the transported recording medium is abutting on the abutting portion, a retracting portion that retracts the abutting portion on which the leading edge of the recording medium is abutting, from a transport path of the recording medium, a rack gear provided in the moving portion, a pinion gear that meshes with the rack gear, that receives a rotational force transmitted from a motor, and that moves the moving portion provided with the rack gear by rotating, and a biasing portion that biases the moving portion to one side in a moving direction of the moving portion and that maintains a biasing force to be the same regardless of a moving position of the moving portion.

### BRIEF DESCRIPTION OF THE DRAWINGS

Exemplary embodiment(s) of the present invention will be described in detail based on the following figures, wherein:

FIG. 1 is a schematic configuration diagram illustrating an image forming apparatus according to a first exemplary embodiment of the present disclosure;

FIG. 2 is a configuration diagram illustrating a toner image forming portion provided in the image forming apparatus according to the first exemplary embodiment of the present disclosure;

FIG. 3 is a perspective view illustrating a medium transport device according to the first exemplary embodiment of the present disclosure;

FIG. 4 is a perspective view illustrating a moving portion provided in the medium transport device according to the first exemplary embodiment of the present disclosure;

FIG. 5 is a perspective view illustrating the moving portion provided in the medium transport device according to the first exemplary embodiment of the present disclosure;

FIG. 6 is a block diagram illustrating a control portion provided in the medium transport device according to the first exemplary embodiment of the present disclosure;

FIG. 7 is an operation diagram for describing an operation of the medium transport device according to the first exemplary embodiment of the present disclosure;

FIG. 8 is an operation diagram for describing the operation of the medium transport device according to the first exemplary embodiment of the present disclosure;

FIG. 9 is an operation diagram for describing the operation of the medium transport device according to the first exemplary embodiment of the present disclosure;

FIG. 10 is a perspective view illustrating a moving portion provided in a medium transport device according to a second exemplary embodiment of the present disclosure;

FIG. 11 is a block diagram illustrating a control portion provided in the medium transport device according to the second exemplary embodiment of the present disclosure;

FIG. 12 is a perspective view illustrating a moving portion provided in a medium transport device according to a third exemplary embodiment of the present disclosure; and

FIG. 13 is a block diagram illustrating a control portion provided in the medium transport device according to the third exemplary embodiment of the present disclosure.

### DETAILED DESCRIPTION

### First Exemplary Embodiment

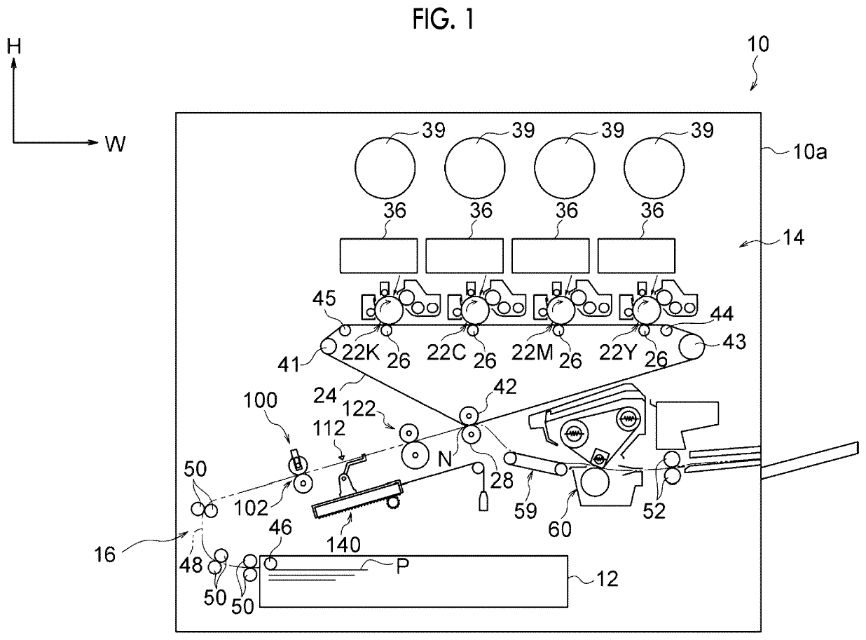

Examples of a medium transport device and an image forming apparatus according to a first exemplary embodiment of the present disclosure will be described in accordance with FIGS. 1 to 9. Arrow H illustrated in each drawing indicates a top-to-bottom direction of the apparatus that is a vertical direction. Arrow W indicates a width direction of the apparatus that is a horizontal direction and is orthogonal to arrow H. Arrow D indicates a depth direction of the apparatus that is the horizontal direction and is orthogonal to arrow H and arrow W.

### Overall Configuration of Image Forming Apparatus

As illustrated in FIG. 1, an image forming apparatus 10 includes a housing 10a accommodating each constituent. An accommodation portion 12, an image forming portion 14, and a transport portion 16 are provided in the housing 10a.

The accommodation portion 12 accommodates a sheet-shaped recording medium P. The image forming portion 14 forms an image on the recording medium P. The transport portion 16 transports the recording medium P from the accommodation portion 12 to the image forming portion 14.

### Image Forming Portion 14

The image forming portion 14 includes image forming units 22Y, 22M, 22C, and 22K (hereinafter, “22Y to 22K”), an intermediate transfer belt 24, primary transfer rolls 26, a secondary transfer roll 28, and a fixing device 60.

The image forming units 22Y to 22K form toner images of each color of yellow (Y), magenta (M), cyan (C), and black (K). The toner images formed by the image forming units 22Y to 22K are transferred to the intermediate transfer belt 24. The primary transfer rolls 26 transfer the toner images formed by each of the image forming units 22Y to 22K to the intermediate transfer belt 24. The secondary transfer roll 28 transfers the toner images transferred to the intermediate transfer belt 24 by the primary transfer rolls 26, from the intermediate transfer belt 24 to the recording medium P. In the following description, Y, M, C, and K at the end of the reference symbols will be omitted in a case where yellow, magenta, cyan, and black are not specifically distinguished from each other.

### Image Forming Unit 22

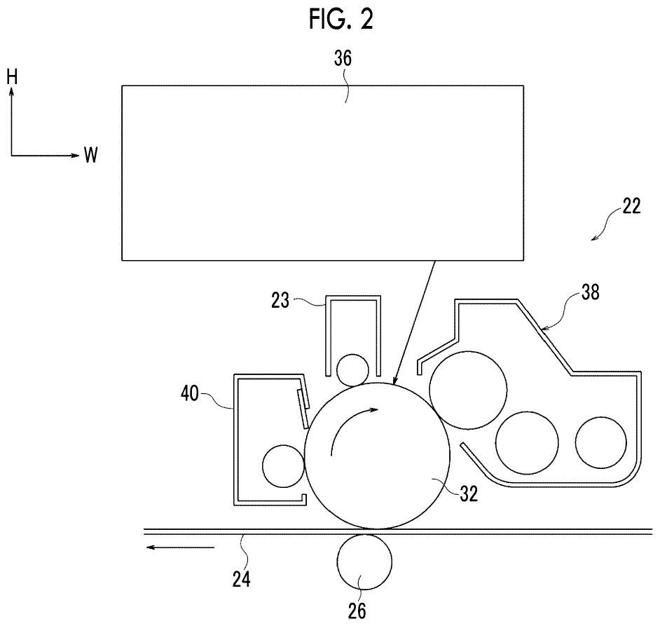

The image forming units 22 of each color are disposed above the intermediate transfer belt 24 and arranged in the width direction. As illustrated in FIG. 2, each image forming unit 22 includes an image carrier 32 that rotates in a direction of the arrow in the drawing.

A charging device 23, an exposing device 36, a developing device 38, and a removing device 40 are provided around the image carrier 32 in this order from an upstream side in a rotation direction of the image carrier 32.

The charging device 23 charges the image carrier 32. The exposing device 36 forms an electrostatic latent image on the image carrier 32 by exposing the image carrier 32 charged by the charging device 23 to light. The developing device 38 forms the toner image by developing the electrostatic latent image. The removing device 40 comes into contact with the image carrier 32 and removes toner remaining on the image carrier 32.

As illustrated in FIG. 1, each of toner accommodation portions 39 accommodating toner to be supplied to the developing devices 38 of the image forming units 22 is disposed above the exposing devices 36 of each color.

### Intermediate Transfer Belt 24, Primary Transfer Roll 26, and Secondary Transfer Roll 28

The intermediate transfer belt 24 is formed in a triangular shape of which an apex is present at a lower position. Winding rolls 41, 42, 43, 44, and 45 on which the intermediate transfer belt 24 is wound are provided on an inner peripheral side of the intermediate transfer belt 24. For example, by rotationally driving the winding roll 43, the intermediate transfer belt 24 rotates in one direction (for example, a counterclockwise direction in FIG. 1) while being in contact with the image carrier 32.

The primary transfer rolls 26 of each color face each image carrier 32 with the intermediate transfer belt 24 interposed between the primary transfer rolls 26 and the image carriers 32. The secondary transfer roll 28 faces the winding roll 42 with the intermediate transfer belt 24 interposed between the secondary transfer roll 28 and the winding roll 42. A second transfer position N at which the toner images transferred to the intermediate transfer belt 24 are transferred to the recording medium P is set between the secondary transfer roll 28 and the winding roll 42.

### Fixing Device 60

The fixing device 60 is disposed on a downstream side of the second transfer position N in a transport direction of the recording medium P (hereinafter, referred to as a “medium transport direction”). The fixing device 60 fixes the toner images transferred to the recording medium P on the recording medium P.

### Transport Portion 16

The transport portion 16 includes a feed roll 46 that feeds the recording medium P accommodated in the accommodation portion 12, and a transport roll 50 that transports the recording medium P fed by the feed roll 46 along a transport path 48 on which the recording medium P is transported.

The transport portion 16 includes a medium transport device 100 that corrects oblique movement of the transported recording medium P. The transport portion 16 includes a belt transport portion 59 that transports the recording medium P on which the toner images are transferred by the secondary transfer roll 28 to the fixing device 60, and a discharge roll 52 that discharges the recording medium P on which the toner images are fixed from the housing 10a. Details of the medium transport device 100 will be described later.

### Image Forming Operation

Next, an image forming operation of forming an image on the recording medium P in the image forming apparatus 10 according to the present exemplary embodiment will be described.

In the image forming apparatus 10 illustrated in FIG. 1, the recording medium P fed from the accommodation portion 12 by the transport portion 16 is fed to the second transfer position N. Meanwhile, in the image forming units 22 of each color, the image carriers 32 charged by the charging devices 23 are exposed to light by the exposing devices 36, and the electrostatic latent images are formed on the image carriers 32 (see FIG. 2). The electrostatic latent images are developed by the developing devices 38, and the toner images are formed on the image carriers 32.

The toner images of each color formed by the image forming units 22 are superimposed with each other on the intermediate transfer belt 24 at a first transfer position by the primary transfer rolls 26 of each color, and a color image is formed. The color image formed on the intermediate transfer belt 24 is transferred to the recording medium P at the second transfer position N by the secondary transfer roll 28.

The recording medium P on which the toner images are transferred is transported to the fixing device 60 by the belt transport portion 59, and the transferred toner images are fixed by the fixing device 60. The recording medium P on which the toner images are fixed is discharged from the housing 10a by the discharge roll 52.

### Basic Configuration

Next, a configuration of the medium transport device 100 will be described. As illustrated in FIG. 1, the medium transport device 100 is disposed on an upstream side of the second transfer position N in the medium transport direction.

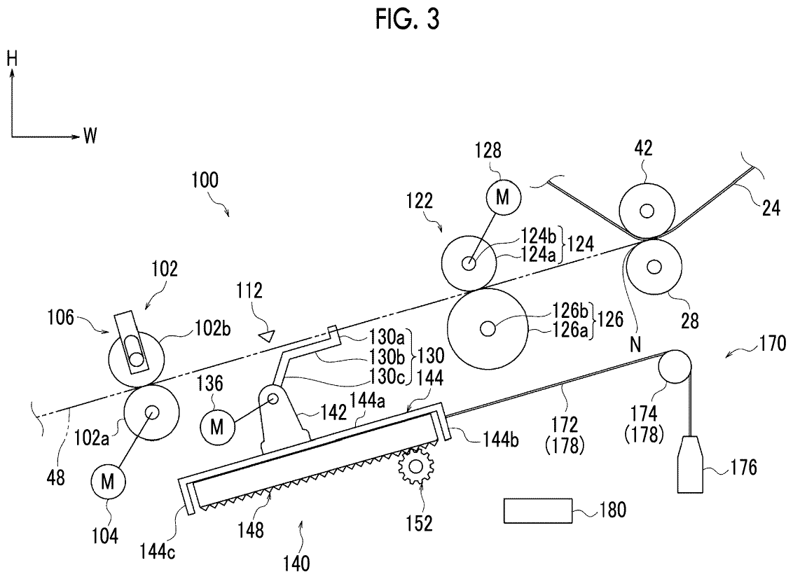

As illustrated in FIG. 3, the medium transport device 100 is disposed along the transport path 48 in a part that is inclined with respect to the width direction such that the upstream side is at a lower position than the downstream side in the medium transport direction. The medium transport device 100 includes a forwarding roll 102, a detection portion 112, a receiving roll 122, abutting portions 130, and a retracting portion 136. The medium transport device 100 includes a moving portion 140, pinion gears 152, a biasing portion 170, and a control portion 180.

### Forwarding Roll 102, Detection Portion 112, and Receiving Roll 122

### Forwarding Roll 102 and Detection Portion 112

As illustrated in FIG. 3, the forwarding roll 102, the detection portion 112, and the receiving roll 122 are disposed in this order from the upstream side to the downstream side along the medium transport direction.

The forwarding roll 102 includes a driving roll 102a disposed below the transport path 48, and a driven roll 102b disposed on a side of the transport path 48 opposite to the driving roll 102a. Axial directions of the driving roll 102a and the driven roll 102b are the depth direction.

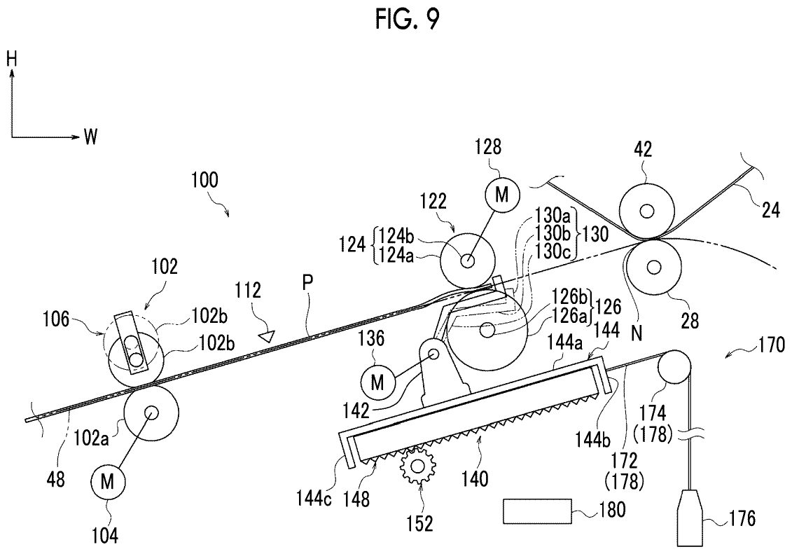

The medium transport device 100 includes a driving portion 104 that applies a rotational force to the driving roll 102a, and a contact and separation portion 106 that brings the driven roll 102b into contact with the driving roll 102a and separates the driven roll 102b from the driving roll 102a. Accordingly, the driven roll 102b moves between a contact position at which the driven roll 102b comes into contact with the driving roll 102a, and a separation position (see a two-dot chain line in FIG. 9) at which the driven roll 102b is separated from the driving roll 102a.

The detection portion 112 is disposed above the transport path 48. The detection portion 112 detects a leading edge of the recording medium P transported along the transport path 48.

### Receiving Roll 122

The receiving roll 122 includes a driving roll 124 disposed above the transport path 48 and a driven roll 126 disposed on a side of the transport path 48 opposite to the driving roll 124. Axial directions of the driving roll 124 and the driven roll 126 are the depth direction. The driving roll 124 includes a plurality of roll portions 124a that have cylindrical shapes and are separated from each other in the depth direction, and a shaft portion 124b that passes through the plurality of roll portions 124a.

The driven roll 126 includes a plurality of roll portions 126a that have cylindrical shapes and are separated from each other in the depth direction, and a shaft portion 126b that passes through the plurality of roll portions 126a. A difference between outer diameters of the roll portions 126a and an outer diameter of the shaft portion 126b is configured to be large in order to avoid interference with the abutting portions 130 when retracting.

The medium transport device 100 includes a driving portion 128 that applies a rotational force to the driving roll 124.

### Abutting Portion 130 and Retracting Portion 136

### Abutting Portion 130

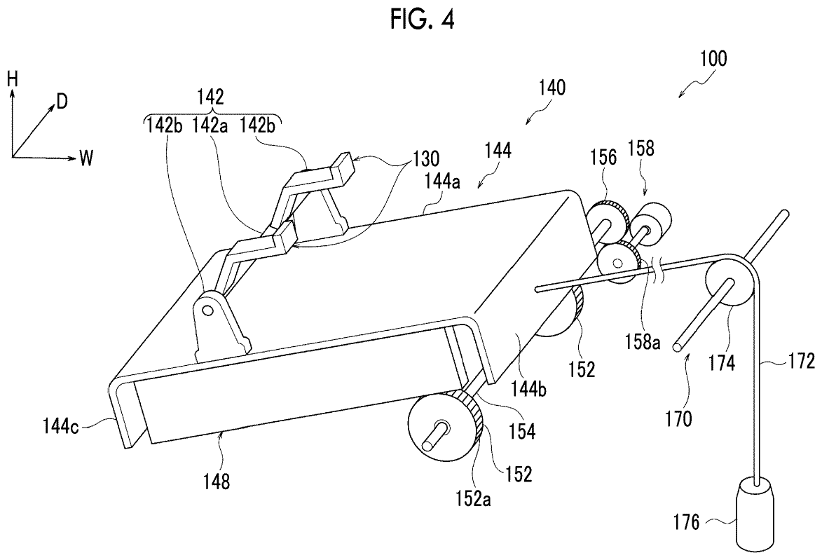

The abutting portions 130 are members on which the leading edge of the recording medium P transported by the forwarding roll 102 abuts. As illustrated in FIG. 4, a plurality of abutting portions 130 are provided separately from each other in the depth direction. As illustrated in FIG. 3, the abutting portions 130 include contact portions 130a that come into contact with the leading edge of the recording medium P and are present across the transport path 48. The abutting portions 130 include body portions 130b that are attached to base ends of the contact portions 130a and extend along the transport path 48. The abutting portions 130 include a rotation shaft of which an axial direction is the depth direction, and support portions 130c that enable the abutting portions 130 to rotate. The abutting portions 130 are configured to be separately disposed in the axial direction in order not to interfere with the driven roll 126 and the driving roll 124.

### Retracting Portion 136

The retracting portion 136 is a member that retracts the abutting portions 130 on which the leading edge of the recording medium P is abutting, from the transport path 48 and, as illustrated in FIG. 3, is a driving member that applies a rotational force to the abutting portions 130.

In this configuration, the retracting portion 136 moves the abutting portions 130 between an abutting position (see FIG. 3) at which the leading edge of the recording medium P abuts on the abutting portions 130 and a retracting position (see the two-dot chain line in FIG. 9) at which the abutting portions 130 are retracted from the transport path 48.

### Moving Portion 140 and Pinion Gear 152

### Moving Portion 140

As illustrated in FIG. 3, the moving portion 140 is disposed below the transport path 48 between the forwarding roll 102 and the receiving roll 122 in the medium transport direction. The abutting portions 130 are attached to the moving portion 140, and a rail portion (not illustrated) enables the moving portion 140 to move in a moving direction along the medium transport direction. The moving portion 140 includes an attachment portion 142, a frame plate 144, and rack gears 148.

As illustrated in FIG. 4, the attachment portion 142 includes a shaft portion 142a constituting the rotation shaft of the abutting portions 130, and a pair of support portions 142b that rotatably support the shaft portion 142a.

As illustrated in FIG. 4, the frame plate 144 includes a body portion 144a that has a plate surface extending along the transport path 48 and a rectangular shape in a view from a plate thickness direction, a flange portion 144b, and a flange portion 144c. The flange portion 144b protrudes from a downstream end of the body portion 144a in the medium transport direction in a direction away from the transport path 48. The flange portion 144c protrudes from an upstream end of the body portion 144a in the medium transport direction in the direction away from the transport path 48. The attachment portion 142 is attached to an upper surface (a surface facing a side closer to the transport path 48) of the body portion 144a.

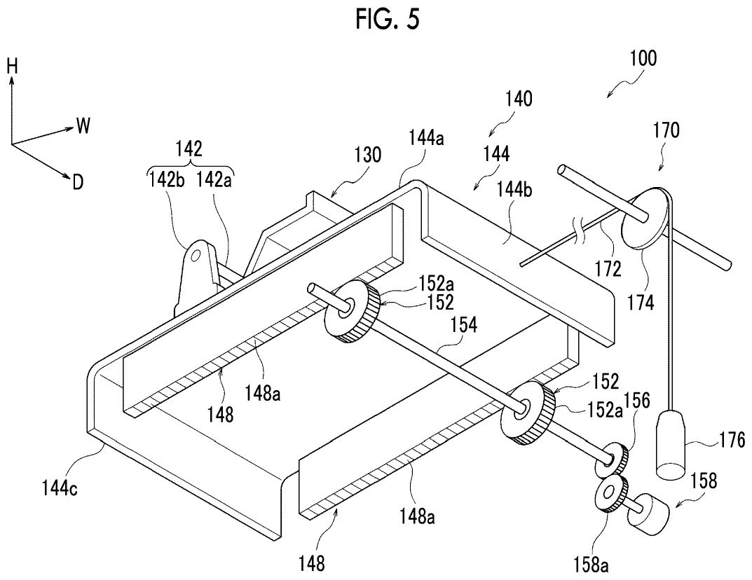

As illustrated in FIG. 5, a pair of rack gears 148 are provided and are attached to a lower surface (a surface on a side opposite to the transport path 48) of the body portion 144a of the frame plate 144. Specifically, the rack gears 148 are attached to both end portions in the depth direction on the lower surface of the body portion 144a and extend in the moving direction of the moving portion 140.

### Pinion Gear 152

As illustrated in FIG. 5, a pair of pinion gears 152 are provided and are disposed such that gear teeth 152a of the pinion gears 152 mesh with gear teeth 148a of the rack gears 148. The pair of pinion gears 152 are attached to a shaft portion 154 extending in the depth direction.

The medium transport device 100 includes a motor 158 that applies a rotational force to the pair of pinion gears 152 via the shaft portion 154. Specifically, a gear 156 is attached to a deeper part of the shaft portion 154 in the depth direction. A gear 158a attached to an output shaft of the motor 158 meshes with the gear 156.

In this configuration, in a case where the rotational force of the motor 158 is transmitted to the pinion gears 152, the pinion gears 152 rotate in one direction or the other direction. The moving portion 140 moves to the downstream side or the upstream side in the medium transport direction along the medium transport direction. In other words, the moving portion 140 moves to a downstream side or an upstream side in the moving direction of the moving portion 140 along the medium transport direction.

Specifically, the moving portion 140 to which the abutting portions 130 are attached moves between an upstream position (see FIG. 3) and a downstream position (see FIG. 9). As illustrated in FIG. 3, the upstream position is a position of the moving portion 140 at which the contact portions 130a of the abutting portions 130 are on an upstream side of the receiving roll 122 and a downstream side of the detection portion 112 in the medium transport direction. As illustrated in FIG. 9, the downstream position is a position of the moving portion 140 at which the contact portions 130a of the abutting portions 130 are on a downstream side of the receiving roll 122 in the medium transport direction.

### Biasing Portion 170

As illustrated in FIGS. 3 to 5, the biasing portion 170 includes a string material 172, a fixed pulley 174, and a mass body 176. The string material 172 is an example of a long material.

The fixed pulley 174 is disposed on a downstream side of the moving portion 140 in the medium transport direction, and an axial direction of the fixed pulley 174 is the depth direction. The string material 172 is wound on the fixed pulley 174, and one end of the string material 172 extends downward from the fixed pulley 174. The mass body 176 is suspended from one end of the string material 172.

The other end of the string material 172 extends along the transport path 48 and is attached to the flange portion 144b. The string material 172 and the fixed pulley 174 constitute a conversion portion 178 that converts a direction of a gravitational force generated by the mass body 176 into the moving direction of the moving portion 140. The fixed pulley 174 is an example of a winding portion.

In this configuration, the biasing portion 170 biases the moving portion 140 to one side in the moving direction along the medium transport direction. Specifically, the biasing portion 170 biases the moving portion 140 to one side (the downstream side) in the moving direction by transmitting the gravitational force of the mass body 176 to the moving portion 140 via the string material 172.

In this configuration, a position of the mass body 176 in the top-to-bottom direction is simply changed depending on a moving position of the moving portion 140. Thus, the biasing force provided to the moving portion 140 is maintained to be the same regardless of the moving position of the moving portion 140.

Here, maintaining the biasing force provided to the moving portion 140 to be the same regardless of the moving position of the moving portion 140 means that the biasing force is the same in a case where the moving portion 140 is at the upstream position, in a case where the moving portion 140 is at the downstream position, and in a case where the moving portion 140 is at an intermediate position between the upstream position and the downstream position. Specifically, a structure in which the biasing portion 170 applies the biasing force to the moving portion 140 is configured not to change depending on a position of the moving portion 140.

### Control Portion 180

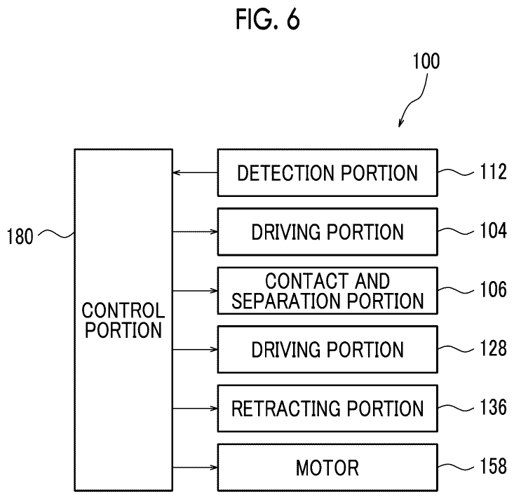

As illustrated in FIG. 6, the control portion 180 receives a detection signal of the detection portion 112 and controls the driving portion 104, the contact and separation portion 106, the driving portion 128, the retracting portion 136, and the motor 158. Control of each portion via the control portion 180 will be described together with action below.

### Action

Next, action of the medium transport device 100 will be described. In an initial state where the forwarding roll 102 has not received the recording medium P, the driven roll 102b is disposed at the contact position, as illustrated in FIG. 3. The abutting portions 130 are disposed at the abutting position, and the moving portion 140 is disposed at the upstream position. Operations or non-operations of each portion described below are executed by controlling each portion via the control portion 180.

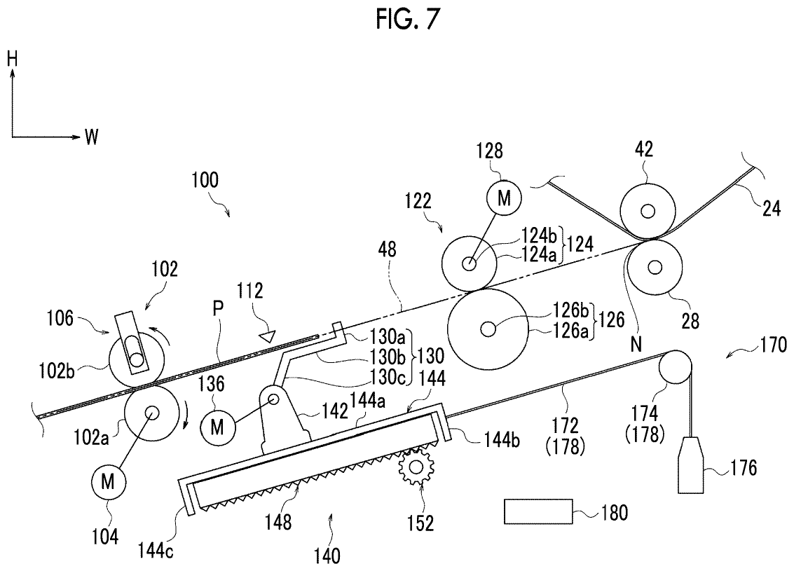

In a case where the image forming apparatus 10 illustrated in FIG. 1 operates, and the recording medium P is fed from the accommodation portion 12, the forwarding roll 102 operates, receives the recording medium P, and transports the recording medium P along the transport path 48, as illustrated in FIGS. 3 and 7. The detection portion 112 detects the leading edge of the transported recording medium P.

After a predetermined time elapses from the detection of the leading edge of the recording medium P by the detection portion 112, the motor 158 (see FIG. 5) operates, and the moving portion 140 at the upstream position moves to the downstream position. Here, a moving speed of the moving portion 140 is lower than a transport speed of the recording medium P transported by the forwarding roll 102.

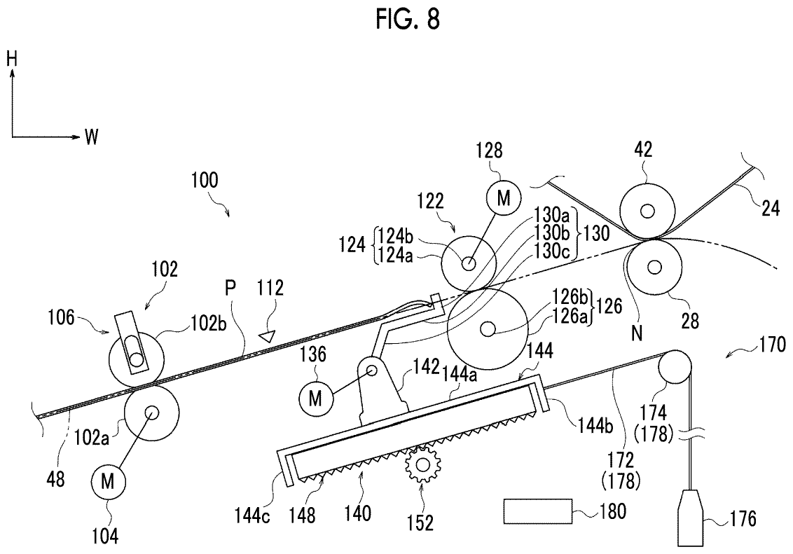

Thus, as illustrated in FIG. 8, the leading edge of the transported recording medium P abuts on the abutting portions 130, and a loop is formed in the leading edge part of the transported recording medium P. Accordingly, the oblique movement (skew) of the recording medium P is eliminated.

The moving portion 140 moves, and as illustrated in FIG. 9, the contact portions 130a of the abutting portions 130 are on the downstream side of the receiving roll 122 in the medium transport direction, and the moving portion 140 reaches the downstream position. In a case where the moving portion 140 reaches the downstream position, the leading edge part of the recording medium P is pinched by the receiving roll 122 operated by the driving portion 128. Here, a transportation speed at which the recording medium P is transported by the receiving roll 122 is lower than the moving speed of the moving portion 140.

In a case where the moving portion 140 reaches the downstream position, the retracting portion 136 operates, and the abutting portions 130 at the abutting position move to the retracting position (two-dot chain line in the drawing). The contact and separation portion 106 operates, and the driven roll 102b at the contact position moves to the separation position (two-dot chain line in the drawing). The rotating receiving roll 122 transports the recording medium P to the second transfer position N. By doing so, the medium transport device 100 passes the recording medium P to the second transfer position N corresponding to a subsequent step.

Here, the moving portion 140 that moves from the upstream position to the downstream position is biased to one side in the moving direction along the medium transport direction by the biasing portion 170. Specifically, the biasing portion 170 biases the moving portion 140 to one side in the moving direction by transmitting the gravitational force of the mass body 176 to the moving portion 140 via the string material 172. Here, the position of the mass body 176 in the top-to-bottom direction simply changes depending on the moving position of the moving portion 140.

Accordingly, the biasing force provided to the moving portion 140 is maintained to be the same regardless of the moving position of the moving portion 140, and occurrence of a backlash in meshing between the gear teeth 148a of the rack gears 148 and the gear teeth 152a of the pinion gears 152 is reduced.

In a case where the moving portion 140 reaches the downstream position, the abutting portions 130 move to the retracting position, and the driven roll 102b moves to the retracting position, the motor 158 (see FIG. 5) rotates in a reverse direction. The moving portion 140 at the downstream position is moved to the upstream position illustrated in FIG. 3 by a driving force of the motor 158. In a case where a trailing edge of the transported recording medium P passes through the abutting portions 130, the abutting portions 130 at the retracting position are moved to the abutting position by the retracting portion 136. The contact and separation portion 106 operates, and the driven roll 102b at the separation position moves to the contact position. Accordingly, the medium transport device 100 is restored to an initial position.

### Conclusion

As described above, in the medium transport device 100, the biasing portion 170 biases the moving portion 140 to one side in the moving direction of the moving portion 140 in order to reduce the occurrence of the backlash in meshing between the rack gears 148 and the pinion gears 152. The biasing force provided to the moving portion 140 by the biasing portion 170 is maintained to be the same regardless of the moving position of the moving portion 140.

Here, in order to reduce occurrence of a backlash in meshing between the rack gear and the pinion gear, the moving portion may be biased to one side in the moving direction using a coil spring. However, the amount of extension (an amount of compression) of the coil spring changes depending on the moving position of the moving portion. Thus, the biasing force provided to the moving portion by the coil spring changes, movement of the moving portion is not stable, and the position of the moving portion 140 in passing the recording medium P to the second transfer position N may vary between recording media P. However, as described above, in the medium transport device 100, the biasing force provided to the moving portion 140 by the biasing portion 170 is maintained to be the same regardless of the moving position of the moving portion 140. Thus, in the medium transport device 100, variation in the position of the moving portion 140 between the recording media P in passing the recording medium P to the subsequent step (in retracting the abutting portions) after reducing the occurrence of the backlash in meshing between the rack gears 148 and the pinion gears 152 is reduced, compared to a case where the moving portion is biased to one side in the moving direction using a spring.

In the medium transport device 100, the biasing portion 170 biases the moving portion 140 using the gravitational force of the mass body 176. Accordingly, power consumption is reduced, compared to a case where the moving portion is biased by a rotational force of a motor.

In the medium transport device 100, the conversion portion 178 that converts the gravitational force generated by the mass body 176 into the moving direction of the moving portion 140 includes the string material 172 and the fixed pulley 174. Accordingly, a simple structure is achieved, compared to a case where the direction of the gravitational force is mechanically converted into the moving direction.

In the image forming apparatus 10, oblique movement correction is improved, compared to a case where a medium transport device that biases the moving portion to the opposite side in the medium transport direction using a spring is provided. Thus, variation in an image position of the recording medium P between the recording media P is reduced.

### Second Exemplary Embodiment

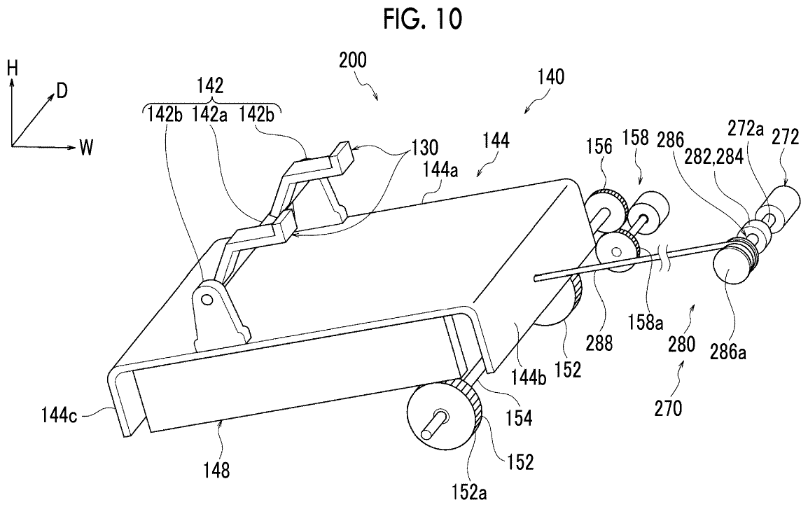

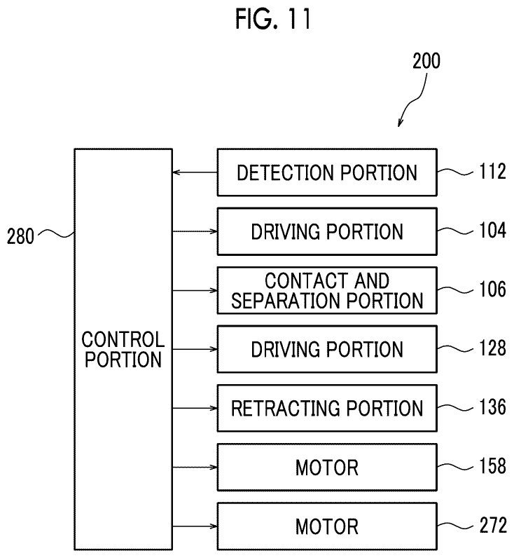

Examples of a medium transport device and an image forming apparatus according to a second exemplary embodiment of the present disclosure will be described in accordance with FIGS. 10 and 11. The second exemplary embodiment will be described with focus on differences from the first exemplary embodiment.

### Configuration

A medium transport device 200 according to the second exemplary embodiment includes the forwarding roll 102, the detection portion 112, the receiving roll 122, the abutting portions 130, and the retracting portion 136. Furthermore, as illustrated in FIG. 10, the medium transport device 200 includes the moving portion 140, the pinion gears 152, a biasing portion 270, and a control portion 280 (see FIG. 11).

The biasing portion 270 includes a motor 272 and a conversion portion 278 that converts a direction of a rotational force generated by the motor 272 into the moving direction of the moving portion 140. The motor 272 is an example of another motor.

The motor 272 is disposed on one side (the right side in the drawing) in the moving direction of the moving portion 140, and a shaft portion 272a of the motor 272 extends in the depth direction.

The conversion portion 278 includes a torque limiter 282 and a one-way clutch 284 attached to the shaft portion 272a, and a string material 288. A base end of an output shaft 286 is attached to the torque limiter 282 and the one-way clutch 284 attached to the shaft portion 272a. The torque limiter 282 limits a rotational force (torque) transmitted to the output shaft 286. The one-way clutch 284 allows the moving portion 140 disposed at the downstream position to move to the upstream position. The string material 288 is an example of the long material. The torque limiter 282 and the one-way clutch 284 may be directly attached to the shaft portion 272a or may be indirectly attached to the shaft portion 272a via a single or a plurality of gears or the like.

A winding portion 286a is provided at a tip end of the output shaft 286. One end of the string material 288 of which the other end is attached to the winding portion 286a is attached to the flange portion 144b.

As illustrated in FIG. 11, the control portion 280 receives the detection signal of the detection portion 112 and controls the driving portion 104, the contact and separation portion 106, the driving portion 128, the retracting portion 136, the motor 158, and the motor 272. Control of each portion via the control portion 280 will be described together with action below.

### Action

Next, action of the medium transport device 200 will be described. As illustrated in FIG. 10, the moving portion 140 that moves from the upstream position to the downstream position is biased to one side in the moving direction along the medium transport direction by the biasing portion 270. Thus, the occurrence of the backlash in meshing between the gear teeth 148a of the rack gears 148 and the gear teeth 152a of the pinion gears 152 is reduced.

Specifically, the rotational force (torque) generated by the motor 272 controlled by the control portion 280 is limited to a predetermined value by the torque limiter 282 and is transmitted to the moving portion 140 via the string material 288 wound by the winding portion 286a. Accordingly, the biasing portion 270 biases the moving portion 140 to one side in the moving direction. Here, the rotational force (torque) limited by the torque limiter 282 does not change depending on the moving position of the moving portion 140. Thus, the biasing force provided to the moving portion 140 is maintained to be the same regardless of the moving position of the moving portion 140.

### Conclusion

As described above, in the medium transport device 200, the biasing portion 270 biases the moving portion 140 using the rotational force generated by the motor 272. Accordingly, a space required for disposing the biasing portion 270 is reduced, compared to a case where the moving portion is biased by the gravitational force of the mass body.

In the medium transport device 200, the rotational force (torque) generated by the motor 272 is limited by the torque limiter 282 and is transmitted to the moving portion 140 via the string material 288. Accordingly, even in a case where the rotational force of the motor 272 is stronger than necessary, the biasing force provided to the moving portion 140 is maintained to be the same.

### Third Exemplary Embodiment

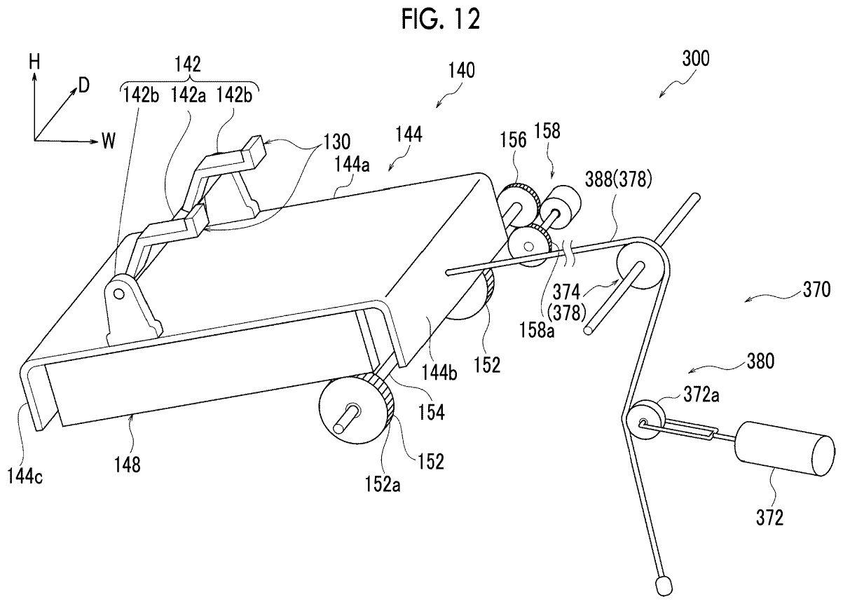

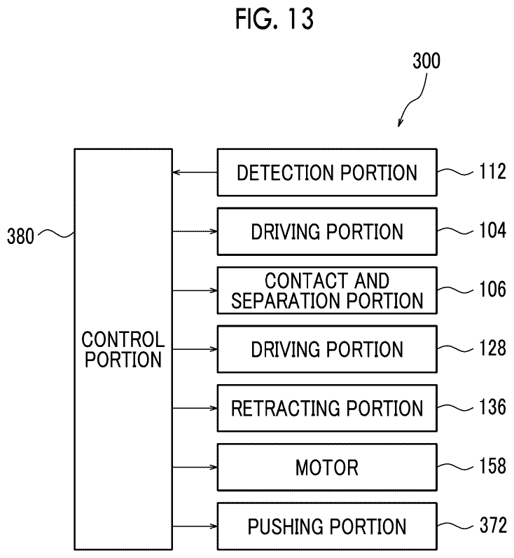

Examples of a medium transport device and an image forming apparatus according to a third exemplary embodiment of the present disclosure will be described in accordance with FIGS. 12 and 13. The third exemplary embodiment will be described with focus on differences from the first exemplary embodiment.

### Configuration

A medium transport device 300 according to the third exemplary embodiment includes the forwarding roll 102, the detection portion 112, the receiving roll 122, the abutting portions 130, and the retracting portion 136. Furthermore, as illustrated in FIG. 12, the medium transport device 300 includes the moving portion 140, the pinion gears 152, a biasing portion 370, and a control portion 380 (see FIG. 13).

The biasing portion 370 includes a pushing portion 372 and a conversion portion 378 that converts a direction of a pushing force generated by the pushing portion 372 into the moving direction of the moving portion 140.

The pushing portion 372 is disposed on one side (the right side in the drawing) in the moving direction of the moving portion 140 and is disposed to extend in the width direction.

The conversion portion 378 includes a string material 388 and a fixed pulley 374. The fixed pulley 374 is disposed above the pushing portion 372, and an axial direction of the fixed pulley 374 is the depth direction.

One end part of the string material 388 of which the other end is attached to the flange portion 144b is wound on the fixed pulley 374, and one end of the string material 388 extends downward. One end of the string material 388 is fixed to a frame by a fixing member (not illustrated).

The pushing portion 372 pushes the string material 388 via a pulley 372a provided in the pushing portion 372. Specifically, the pushing portion 372 pushes a part of the string material 388 from the fixed pulley 374 to one end, from one side (the right side in the drawing) to the other side (the left side in the drawing) in the width direction, and this pushing force is the same regardless of a posture of the string material 388.

As illustrated in FIG. 13, the control portion 380 receives the detection signal of the detection portion 112 and controls the driving portion 104, the contact and separation portion 106, the driving portion 128, the retracting portion 136, the motor 158, and the pushing portion 372. Control of each portion via the control portion 380 will be described together with action below.

### Action

Next, action of the medium transport device 300 will be described. The moving portion 140 that moves from the upstream position to the downstream position is biased to one side in the moving direction along the medium transport direction by the biasing portion 370. Thus, the occurrence of the backlash in meshing between the gear teeth 148a of the rack gears 148 and the gear teeth 152a of the pinion gears 152 is reduced.

Specifically, the pushing force provided to the string material 388 by the pushing portion 372 is transmitted to the moving portion 140 via the string material 388. Accordingly, the biasing portion 370 biases the moving portion 140 to one side in the moving direction. Here, the pushing force with which the pushing portion 372 pushes the string material 388 does not change depending on the moving position of the moving portion 140. Thus, the biasing force provided to the moving portion 140 is maintained to be the same regardless of the moving position of the moving portion 140.

While the present disclosure is described in detail with respect to specific exemplary embodiments, the present disclosure is not limited to such exemplary embodiments, and those skilled in the art will perceive that other various exemplary embodiments of the present disclosure are available within the scope of the present disclosure. While the medium transport devices 100, 200, and 300 include the control portions 180, 280, and 380 in the above exemplary embodiments, a part of the control portion of the image forming apparatus 10 may also serve as the control portion of the medium transport device.

In the above exemplary embodiments, the moving portion 140 is biased by pulling the moving portion 140 to one side in the moving direction via the biasing portions 170, 270, and 370. However, the moving portion may be biased by pushing the moving portion to one side in the moving direction via the biasing portion.

While the moving portion 140 is biased to one side in the moving direction by the biasing portions 170, 270, and 370 in the above exemplary embodiments, the moving portion may be biased to the other side in the moving direction by the biasing portion. In this case, the other side of the moving portion 140 according to the present exemplary embodiment is the one side of the moving portion.

While two abutting portions 130 are provided in the above exemplary embodiments, the number of abutting portions 130 may be three or more.

While particular description is not provided in the above exemplary embodiments, the moving portions may be biased by a magnetic force. In this case, the biasing force can be maintained to be the same regardless of the moving position of the moving portion by changing the magnetic force depending on the position of the moving portion.

While particular description is not provided in the above exemplary embodiments, other rolls may be provided between the receiving roll 122 and the second transfer position N.

(((1)))

A medium transport device comprising:
an abutting portion on which a leading edge of a transported recording medium abuts;
a moving portion to which the abutting portion is attached, that is movable along a transport direction of the recording medium, and that moves to a downstream side in the transport direction at a speed slower than a transport speed of the recording medium in a state where the leading edge of the transported recording medium is abutting on the abutting portion;
a retracting portion that retracts the abutting portion on which the leading edge of the recording medium is abutting, from a transport path of the recording medium;
a rack gear provided in the moving portion;
a pinion gear that meshes with the rack gear, that receives a rotational force transmitted from a motor, and that moves the moving portion provided with the rack gear by rotating; and
a biasing portion that biases the moving portion to one side in a moving direction of the moving portion and that maintains a biasing force to be the same regardless of a moving position of the moving portion.
   (((2)))

The medium transport device according to (((1))),
wherein the biasing portion includes
   a mass body, and
   a conversion portion that converts a direction of a gravitational force generated by the mass body into the moving direction.
      (((3)))

The medium transport device according to (((2))),
wherein the conversion portion includes
   a long material of which one end is attached to the mass body and of which the other end is attached to the moving portion, and
   a winding portion on which the long material is wound such that the mass body is suspended by one end portion of the long material, and the moving portion is pulled in the moving direction by the other end portion of the long material.
      (((4)))

The medium transport device according to (((1))),
wherein the biasing portion includes
   another motor, and
   a conversion portion that converts a rotational force generated by the other motor into the moving direction.
      (((5)))

The medium transport device according to (((4))),
wherein the conversion portion includes
   a torque limiter that is attached to a shaft portion of the other motor and that includes a winding portion, and
   a long material of which one end is attached to the winding portion of the torque limiter in a windable manner, of which the other end is attached to the moving portion, and that extends in the moving direction.
      (((6)))

An image forming apparatus comprising:
the medium transport device according to any one of (((1))) to (((5))); and
an image forming portion that forms an image on the recording medium transported by the medium transport device.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A medium transport device comprising:
an abutting portion on which a leading edge of a transported recording medium abuts;
a moving portion to which the abutting portion is attached, that is movable along a transport direction of the recording medium, and that moves to a downstream side in the transport direction at a speed slower than a transport speed of the recording medium in a state where the leading edge of the transported recording medium is abutting on the abutting portion;
a retracting portion that retracts the abutting portion on which the leading edge of the recording medium is abutting, from a transport path of the recording medium;
a rack gear provided in the moving portion;
a pinion gear that meshes with the rack gear, that receives a rotational force transmitted from a motor, and that moves the moving portion provided with the rack gear by rotating; and
a biasing portion that biases the moving portion to one side in a moving direction of the moving portion and that maintains a biasing force to be the same regardless of a moving position of the moving portion.

2. The medium transport device according to claim 1,
wherein the biasing portion includes
a mass body, and
a conversion portion that converts a direction of a gravitational force generated by the mass body into the moving direction.

3. The medium transport device according to claim 2,
wherein the conversion portion includes
a long material of which one end is attached to the mass body and of which the other end is attached to the moving portion, and
a winding portion on which the long material is wound such that the mass body is suspended by one end portion of the long material, and the moving portion is pulled in the moving direction by the other end portion of the long material.

4. The medium transport device according to claim 1,
wherein the biasing portion includes
another motor, and
a conversion portion that converts a rotational force generated by the other motor into the moving direction.

5. The medium transport device according to claim 4,
wherein the conversion portion includes
a torque limiter that is attached to a shaft portion of the other motor and that includes a winding portion, and
a long material of which one end is attached to the winding portion of the torque limiter in a windable manner, of which the other end is attached to the moving portion, and that extends in the moving direction.

6. An image forming apparatus comprising:
the medium transport device according to claim 1; and
an image forming portion that forms an image on the recording medium transported by the medium transport device.

7. An image forming apparatus comprising:
the medium transport device according to claim 2; and
an image forming portion that forms an image on the recording medium transported by the medium transport device.

8. An image forming apparatus comprising:
the medium transport device according to claim 3; and
an image forming portion that forms an image on the recording medium transported by the medium transport device.

9. An image forming apparatus comprising:
the medium transport device according to claim 4; and
an image forming portion that forms an image on the recording medium transported by the medium transport device.

10. An image forming apparatus comprising:
the medium transport device according to claim 5; and
an image forming portion that forms an image on the recording medium transported by the medium transport device.
